(19) United States
(12) Patent Application Publication
(10) Pub. No.: US 2017/0205328 A1
(43) Pub. Date: Jul. 20, 2017

(54) SYSTEM AND METHOD FOR MEASURING PERMEABILITY OF A MATERIAL

(71) Applicant: Building Envelope Analysis, LLC, Seattle, WA (US)

(72) Inventors: Ronald D. Tatley, Edmonds, WA (US); Thomas J. Schneider, Oregon City, OR (US)

(21) Appl. No.: 15/405,594

(22) Filed: Jan. 13, 2017

Related U.S. Application Data
(60) Provisional application No. 62/298,757, filed on Feb. 23, 2016.
(60) Provisional application No. 62/291,864, filed on Feb. 5, 2016.
(60) Provisional application No. 62/278,778, filed on Jan. 14, 2016.

(51) Int. Cl. G01N 15/08; G01F 23/56

(52) U.S. Cl. CPC G01N 15/0826; G01F 23/56

(57) ABSTRACT

Disclosed are a system and method for measuring the permeability of a material. A test chamber includes first and second sides, separated by a material undergoing testing. A blower applies pressurized air to the first side of the chamber, air permeating through the material enters the second side of the chamber where the volume of the permeated air is measured by an air volume measuring device. The measuring device includes first and second float boxes, each suspended in a water tank so that a captured volume of air raises the float box within the water tank. With the volume of air permeated and the elapsed time, the permeability of the material can be calculated. In alternative embodiments additional environmental conditions are introduced, including heat, cooling, and water spray. Field test configurations of the test system are also disclosed.

### CROSS-REFERENCE TO RELATED APPLICATIONS

This application claims priority to U.S. Provisional Application Ser. No. 62/278,778, filed on Jan. 14, 2016; 62/291,864, filed on Feb. 5, 2016; and 62/298,757, filed on Feb. 23, 2016, each of which is hereby incorporated herein by reference in its entirety.

### BACKGROUND

In the building and construction industry, the infiltration and exfiltration of air and/or water vapor into and out of a building is a primary concern of builders and building owners. Any differential pressure conditions that exist throughout the building envelope lead to unmanaged infiltration and exfiltration. This undesired or unexpected flow of air or water vapor permeating through a material can affect the integrity of the building and the materials used to construct the building, can reduce the energy efficiency of a building, and can cause undesired or unexpected load on a building's heating, ventilation, and air conditioning systems. Unmanaged airflow leads to direct heating and cooling loss, and contributes to low indoor air quality and unacceptable comfort levels in buildings. Unmanaged airflow also affects the performance of insulation, the durability of materials and the health of the occupants of a building.

The construction industry has long been aware of the problems associated with the permeability of construction materials, and various testing systems and methods have been devised to detect and measure infiltration and exfiltration, and various products have been developed to eliminate or mitigate the flow of air and water vapor through those materials. Advances in technology and ongoing research in the industry over the past several years have resulted in a generally better understanding of the permeability of building materials. For example, it is now commonplace in residential construction to install an air barrier, such as a building wrap, over the substrate walls before siding is installed. The building wrap is intended to prevent bulk air and moisture leakage into and out of the building while still allowing moisture vapor that may infiltrate the substrate to escape. Such technology has resulted in homes and buildings having much greater energy efficiency than previously possible, and has generally increased the lifespan of building materials as they are better protected from the elements.

However, while such technology has provided some apparent benefits to the building industry, the testing itself has not kept pace with the advancements in technology. In fact, the improvements to the technology have introduced new challenges as those improvements have surpassed the capabilities of the existing test and measurement equipment that led to those very advances.

For instance, current testing of the permeability of a section of substrate or wall is typically accomplished using a calibrated membrane flow device, with the data from the membrane test device being analyzed by a specialized algorithm that calculates the leakage through the substrate based on the measured airflow through the membrane. That testing is typically performed at normal or ambient conditions, i.e., with one side of the substrate exposed to air pressurized to a level equal to that typically found in a building and the flow through the substrate measured as just described. The equipment used for such testing was designed to work optimally with relatively large amounts of air flow, as substrate materials typically had a fairly high level of permeability, so that some minor leakage or loss in the equipment itself was not of concern in comparison to the large air flow being measured through the substrate.

As a result of that testing the permeability of building materials and assemblies became apparent and quantifiable, which led to the widespread use of building wrap in the construction industry. Thus, subsequent permeability testing began to include assemblies that included substrate with building wrap applied—that is, the testing reflected the proposed actual building construction. However, because the building wrap greatly reduced the overall permeability of the substrate, the testing itself was impacted—the equipment and algorithms developed to initially test the permeability were not designed, and do not have the capability, to accurately measure the relatively small air flow resulting from modern construction techniques. Even the leakage of the equipment itself became a significant factor in the test setup. In order to compensate for those deficiencies in the testing equipment, the test setup is often altered such that air pressure applied to the material being tested is increased so that the flow of air through the material is similarly increased, thus the conventional membrane testing equipment can be used to measure that high flow, with the results then being scaled to account for the higher pressure. This compensation method, however, is flawed since the higher pressure air used during testing can induce permeability in a material where no permeability would exist at a lower pressure. Thus, the results of such testing do not reflect the actual permeability of the material under test in real-world conditions.

Furthermore, typical airflow testing does not use or take into account other real-world weather and exposure conditions that occur during actual construction of a building, thus the testing data does not reflect the results that would be expected from testing on an actual building. For example, oriented strand board (OSB) is commonly used throughout the construction industry, such as in the constructions of residential homes. OSB is comprised of multiple layers of wood strands compressed with adhesive, with successive layers of the board having its wood strands oriented in a different direction than the previous layer. The permeability of air through OSB can be measured using conventional instruments and measurement methods to provide a general idea of the expected permeability of the OSB material. However, in real-world conditions, the actual permeability of OSB material can vary greatly depending on its exposure to the elements or the permeation of water into the OSB. When OSB is exposed to water, the adhesive in the layers of oriented wood strands breaks down, and the permeability of the OSB changes—the permeability generally becomes greater as the material breaks down. Thus, water and/or water vapor permeation into the OSB changes its permeability from the baseline permeability established with conventional testing methods.

Finally, current industry test specifications have not kept up with the advances in air barrier and permeability studies and technology. Current industry standards for testing air barriers in the construction industry include ASTM 2357 and ASTM 2178. Both of those testing standards specify test equipment that is not sensitive enough to measure airflow at the low pressures and flow rates that exist in structures built with current technology air barriers. Testing using those standards thus cannot provide meaningful and accurate airflow rates using the one square meter specimens called for in those test protocols, and do not accurately measure the permeability of a structure or material under conditions that the structure will be subject to on a day-to-day basis.

Thus, it can be seen that there remains a need in the art for systems and methods to accurately measure the permeability of construction materials, assemblies, and systems that are performed under real-world conditions, such as the low pressure and low flow conditions that exist in modern buildings, and that there remains a need for improved standards, specifications, data sheets, and a better understanding of the permeability of materials.

### SUMMARY

Embodiments of the invention are defined by the claims below, not this summary. A high-level overview of various aspects of the invention is provided here to introduce a selection of concepts that are further described in the Detailed Description section below. This summary is not intended to identify key features or essential features of the claimed subject matter, nor is it intended to be used in isolation to determine the scope of the claimed subject matter. In brief, this disclosure describes exemplary systems and methods for measuring the permeability of a material.

The system and method of the present invention permit testing of building materials, structural members, assemblies, air barriers, and the like to accurately measure and determine the permeability of the material being tested under real-world environmental and pressure conditions.

In one aspect, the invention provides a test chamber having a first side for applying environmental conditions and pressurized air to one side of a substrate or other building material, and a second side for receiving air and water vapor that permeates through the material under test. The substrate material being tested is mounted between the two sides, sealed at its outer perimeter such that the only pathway for air or water vapor flow between the two sides is through the substrate material. The first and second halve of the test chamber are likewise sealed from the ambient environment existing outside of the chamber. After an initial normalization and calibration, the permeability of the substrate material is determined by precisely measuring the volume of air that flows into the second side over a period of time.

In another aspect, the invention provides an air volume measurement device having first and second water tanks, with first and second float boxes suspended in the corresponding water tank. Air from the second side of the chamber is introduced into one of the float boxes, the displacement of the float box corresponds to the volume of air received. In yet another aspect, the flow of air from the second side of the chamber is alternately directed to the first and second float boxes and the cumulative total volume of air captured over a period of time is recorded.

In another aspect, the present invention allows precise measurement of the permeability of a small, localized section of a substrate being tested, such as the area around a fastener extending through the substrate. The localized testing can be accomplished in the test chamber using an alternative configuration of the test chamber equipment, or can be accomplished in the field, using a minimized, portable version of the test chamber.

Various objects and advantages of this invention will become apparent from the following description taken in relation to the accompanying drawings wherein are set forth, by way of illustration and example, certain embodiments of this invention.

The drawings constitute a part of this specification, include exemplary embodiments of the present invention, and illustrate various objects and features thereof.

### DESCRIPTION OF THE DRAWINGS

Illustrative embodiments of the invention are described in detail below with reference to the attached drawing figures, and wherein:

FIG. 1 is a front perspective view of a test system in accordance with an exemplary embodiment of the present invention.

FIG. 2 is a schematic diagram of a test system for measuring the permeability of a material in accordance with an exemplary embodiment of the present invention.

FIG. 3 through FIG. 16 are schematic diagrams depicting the operation during permeability testing of the system of FIG. 2.

FIG. 17 is a schematic diagram of a test system for measuring the permeability of a material in accordance with alternative exemplary embodiments of the present invention.

FIG. 18 is a perspective view of the test system of FIG. 1 positioned for use in conjunction with a storm surge environmental test chamber used to introduce environmental conditions to the material under test.

FIG. 19 is a schematic diagram of an exemplary orifice calibration test setup for use with an exemplary embodiment of the test system of the present invention.

FIG. 20 through FIG. 30 are schematic diagrams of an exemplary bench or field test configuration for measuring the permeability of a material in accordance with an exemplary embodiment of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

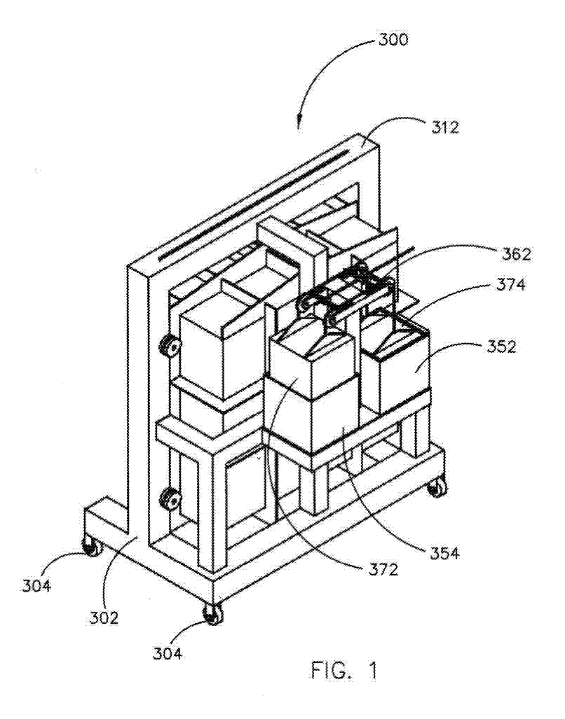

Looking to FIG. 1, a system for measuring the permeability of a material in accordance with an exemplary embodiment of the present invention is depicted generally by the numeral 300. The system is configured onto a rigid frame 302 which supports the various components, with a plurality of casters 304 attached to the lower side of the frame to allow the system to be transported and moved into position, for example, against a storm surge chamber operable to introduce environmental conditions to a material under test as will be described in more detail below.

The test system 300 includes a chamber 312 comprising first and second sides into which a material being tested is placed, positioned between the two sides. Preferably, the material to be tested is of a standard size, such a one square meter, so that direct comparisons of the measured permeability of various materials can be easily performed, although in alternative embodiments the test chamber configuration can be adapted to accommodate test material samples of various sizes. With the material to be tested placed and sealed between the two sides, environmental conditions and/or air pressure is applied to one side of the material, with instrumentation on the other side of the material measuring the permeation of air and/or water vapor through the material.

In the exemplary embodiment shown in FIG. 1, the measurement instrumentation includes a precision device for measuring the volume of flow in to the chamber, the device including first and second water tanks 354, 356, first and second float boxes 372, 374, with a fulcrum 362 connecting float boxes associated with each tank. The operation of the test system and a further description of the instrumentation will be described with respect to schematic diagrams depicting operation of the system.

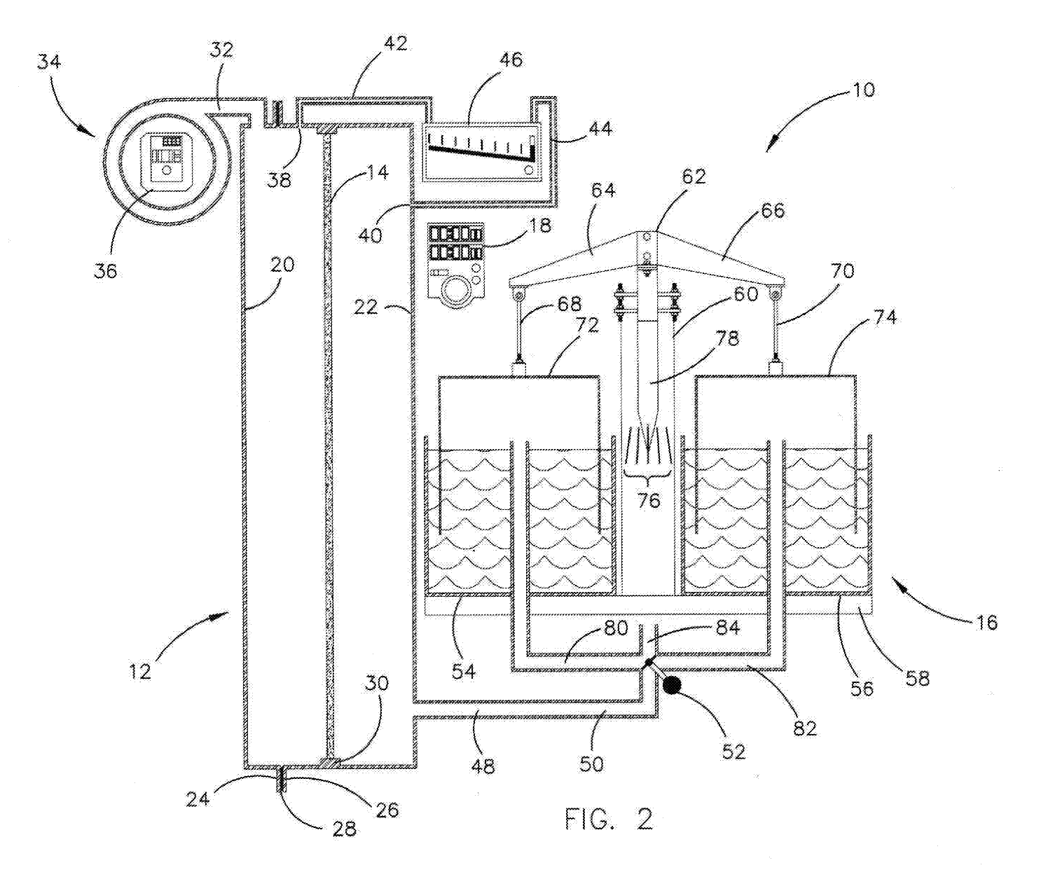

Turning to FIG. 2, a schematic diagram of a test system for measuring the permeability of a material in accordance with an exemplary embodiment of the present invention is depicted generally as numeral 10. The test system 10 includes a sealable chamber 12, configured to secure a material being tested 14 and operable to introduce pressurized air and environmental conditions to the material under test; and an air volume measurement device 16, operable to measure the volume of air that permeates through the material. A timer 18 is operable to measure the time elapsed during the testing. Based on the measured volume of air and the elapsed time as will be described herein, the permeability of the material being tested can be calculated.

Looking still to FIG. 2, the sealable chamber 12 is divided into first and second sides 20, 22, each side having a corresponding flange that extends outwardly around an outer perimeter of the side. The two sides are joined, with a seal 28 extending around, and trapped between, the faces of the flanges to form an airtight seal between the two sides. It should be understood that the depiction in FIG. 2 is a representative cross-sectional view of an exemplary embodiment of the test chamber in which the two sides 20, 22 are rectangular or square in shape, which in conjunction form box-shaped chamber 12 when joined. Preferably, the chamber 12 is greater than 1 meter by 1 meter in size so that a standard 1 square meter material test piece may be positioned within the chamber. However, other sizes and shapes of test chambers are contemplated by and are within the scope of the present invention.

A protruding, rectangular-shaped lip 30 extends inwardly (into the interior of the chamber) around the inner perimeter of the second side 22 of the test chamber, providing a support surface and attachment face for the test specimen 14. With the test specimen 14 sealably attached to the support surface, the interior of the chamber is divided into first and second compartments corresponding generally to the first and second sides of the chamber. An inlet port 32 in communication with the interior of first side 20 allows pressurized air to be introduced into the chamber 12. A blower 34 controlled by an electronic speed controller 36 is in communication with inlet port 32 and is operable to provide pressurized air into the chamber 12. Preferably, blower 34 is a ring compressor and electronic speed controller 36 is in communication with a differential pressure sensor measuring the air pressure on both sides of the test specimen within the chamber such that the speed controller maintains a constant differential pressure during operation. Alternatively, the blower 34 can operate at a fixed speed without regard to the differential pressure.

Each side 20, 22 of the chamber includes a corresponding pressure port 38, 40 to allow monitoring the pressure in each side of the chamber, either individually (e.g., absolutely or relatively) or differentially (between the two sides). In the embodiment depicted in FIG. 1, a hose or tube 42, 44 connects the corresponding pressure port 38, 40 to a manometer 46 operable to measure the differential pressure between the first and second sides 20, 22 of the chamber 12. As will be discussed in more detail below with respect to the operation of the test system, it should be understood that controls and instrumentation described and associated with the test system are preferably capable of communicating with each other and/or a central controller or computer so that information and data can be shared between the various instrumentation and controls. Thus, for example, data representative of the differential pressure between the two sides of the chamber can be provided to the electronic speed controller 36 which is operable to adjust the speed of the blower 34 to thus maintain a desired differential pressure.

An outlet port 48 in communication with the interior of second side 22 allows air to flow from that side of the chamber and to the air volume measurement device 16 through a hose or tubing 50 and a directional valve 52 attached between the two.

The air volume measurement device 16 is operable to precisely and accurately measure the volume of air entering the device. As seen in FIG. 2, the air volume measurement device comprises two water tanks 54, 56 positioned in close proximity on a horizontal platform 58. Each water tank is a five-sided box (i.e., an open-top box), each tank is partially filled with approximately equal amounts of water. A vertical tower 60 extends upwardly from the horizontal platform 58, with a wing-shaped fulcrum 62, having two oppositely extending arms 64, 66 pivotably attached near the top of the tower.

A deflection scale 76 comprising a series of indexed lines is positioned on the midsection of the vertical tower 60, and a pointed dial indicator 78 extends down from the midsection of the fulcrum 62 so that the pointed end of the indicator overlays the indexed lines. The indexed lines of the deflection scale and the pointed end of the dial indicator thus provide an indication of the position of the fulcrum. For example, when the pointed end of the dial indicator is centered directly above the center index line the fulcrum is level or horizontal, and when the pointed end of the dial indicator is deflected off of center the fulcrum is tilted to one side or the other.

A pendant rod 68, 70 is attached to and extends downwardly from the outer end of each extending arm, with first and second inverted five-sided float boxes 72, 74 suspended from each respective rod and into the corresponding water tank 54, 56 on the horizontal platform 58. As seen in the figure, each float box 72, 74 is smaller is size than the corresponding water tank so that the float box fits within the water tank and floats therein due to the buoyancy provided by the quantity of air trapped between the float box and the surface of the water in the water tank.

It should be understood that the junctions of the walls of the water tank and float box assemblies are air-tight and water-tight and that the assemblies are constructed of impermeable material. It should be further understood that the depiction in FIG. 2 is a cross-sectional view of an exemplary embodiment of the air volume measurement device and the associated water tanks and float boxes in which the tanks and boxes are five-sided, square or rectangular in shape. However, other sizes and shapes of water tanks and float boxes may be used, and are contemplated by and are within the scope of the present invention. For example, the water tanks and float boxes may be cylindrical, hexagonal, or any other desired shapes so long as the float box fits within the water tank.

In the exemplary embodiment depicted in FIG. 2, the deflection scale is calibrated such that each index line indicates a deflection of the fulcrum corresponding to a movement of the fulcrum that corresponds to a specific linear (up or down) movement of the float boxes. That linear movement, in turn, corresponds to a specific volume of air displacement within the float boxes, corresponding to the cross-sectional area of the float box multiplied by the linear movement. In the exemplary embodiment shown in FIG. 2, each index line corresponds to a volume of 72 cubic inches of air, thus the volume of air introduced into the float box can be ascertained by the dial indicator and deflection scale readings. For example, with the dial indicator pointed to the first index line past the center line, the corresponding float box contains a volume of 72 cubic inches of air, and with the dial indicator at the second index line, the corresponding float box contains a volume of 144 cubic inches of air.

Thus, in conjunction with the deflection scale 76 and dial indicator 78 as described above, it can be seen that the relative positions of the float boxes 72, 74 can be ascertained by the position of the dial indicator on the deflection scale. For example, if the dial indicator is centered, indicating that the fulcrum is level, then the float boxes are likewise level. In the exemplary embodiment as shown, with the size and shape of the water tanks and the volume of water contained therein being equal, and with the size and shape of the float boxes being equal, the relative positions of the float boxes is directly indicative of the volume of air trapped in each float box.

Looking still to FIG. 1, tubes 80, 82 extend between the directional valve 52 and up through the corresponding water tank 54, 56 so that air exiting from the second side 22 of the chamber 12 can be directed into either float box 72, 74 depending on the position of directional valve 52. As also seen in the drawing, when air is being directed from tube 50 to one of the float boxes by directional valve 52, the other float box is in communication with vent tube 84, which vents to ambient air. Thus, air from the second side 22 of the chamber 12 can be directed to either float box 72, 74 by directional valve 52, with the other float box being vented.

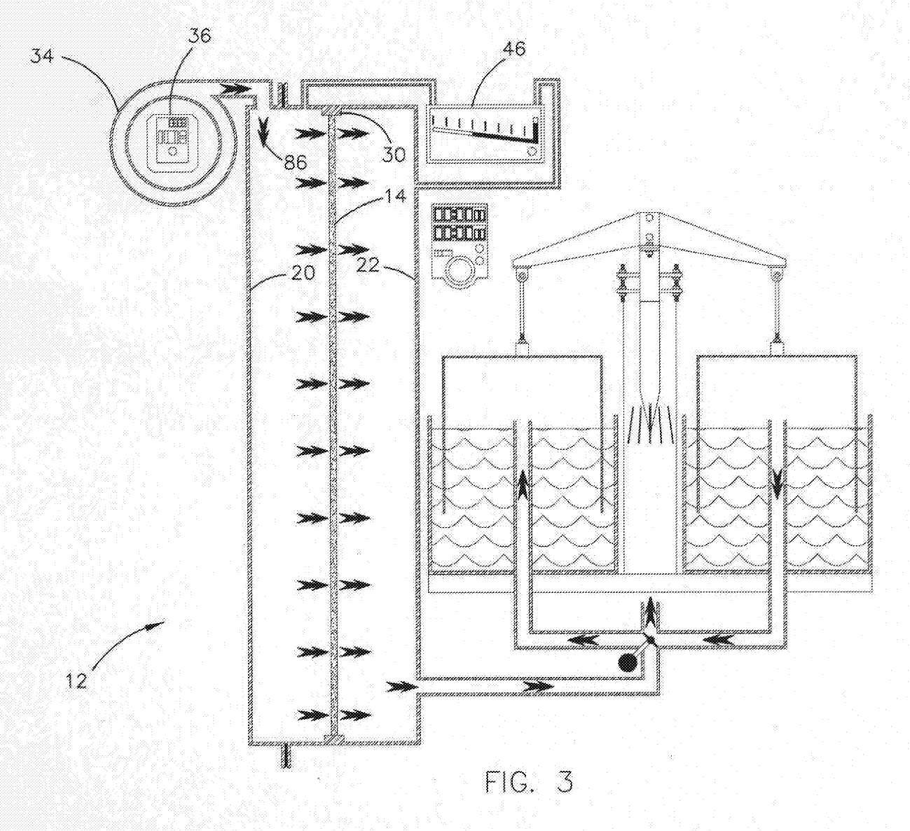

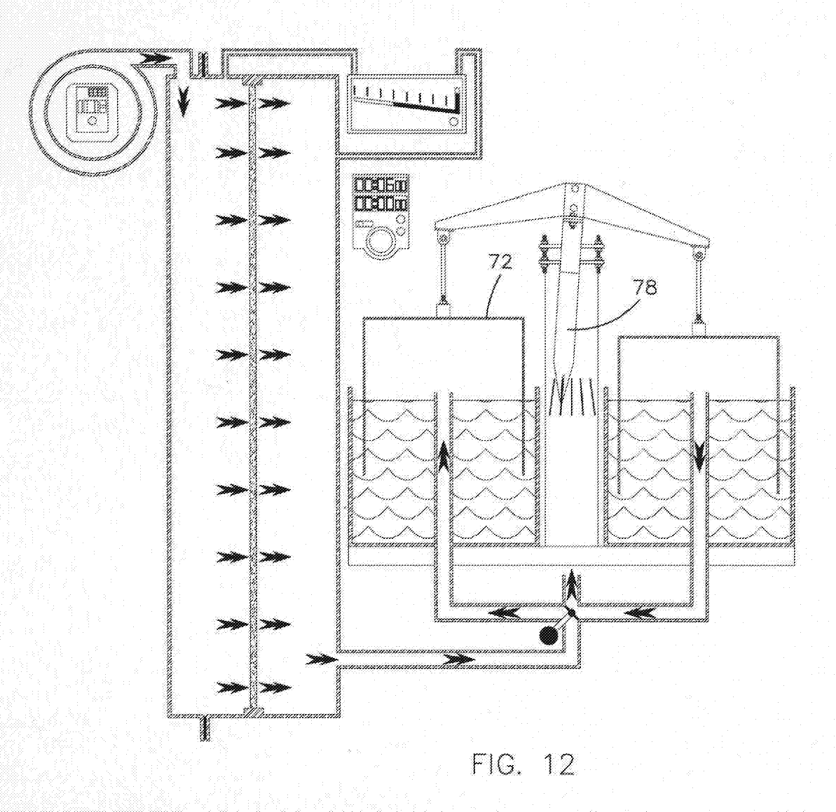

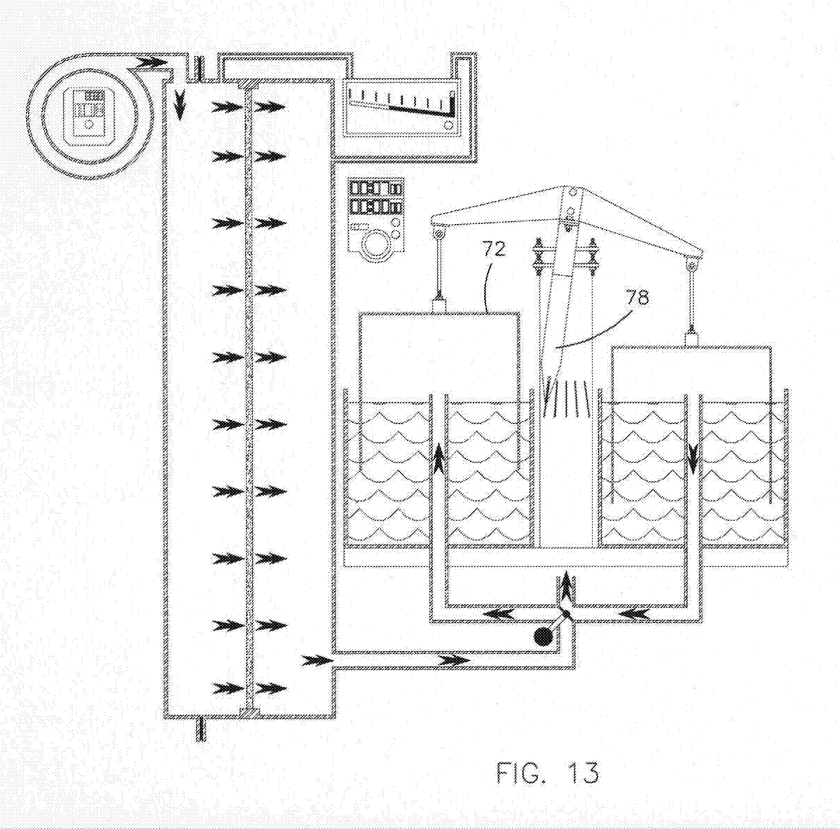

With the structure and elements of the test system 10 set forth, the operation of the test chamber and an exemplary method of measuring the permeability of a material will now be described with respect to the schematic diagrams of FIGS. 3 through 16.

Looking to FIG. 3, a test specimen 14 for which the permeability is to be measured is placed into the second side 22 of the chamber, with the perimeter of the test specimen 14 sealed to the surface of the lip 30 extending around the interior perimeter of the second side of the chamber 12. The test specimen is preferably a continuous specimen of predetermined dimensions corresponding to the dimensions of the lip 30, such as a 1 square meter rigid specimen that is sealed around its edges to lip 30. Or, the specimen may be flexible with a supporting web sealed to the lip 30. The test specimen 14 is preferably placed such that it is supported entirely on the lip, with no obstructions touching either side of the specimen.

Looking still to FIG. 3, with the test specimen 14 in place, the test system is initialized by activating the air speed controller 36 to operate the blower 34 so that pressurized air 86 is introduced into the first side 20 of chamber 12 (air flow throughout the test system is indicated in the figures by double-headed arrows). The speed of the blower is adjusted so that a differential air pressure of 0.3 inches of water (0.3″ Aq) between the two sides 20, 22 of the chamber 12 is established, as indicated on manometer 46. The differential pressure is measured by the manometer through ports 38 and 40 as previously described.

With the desired differential pressure thus established, it should be understood that the first side 20 of the test chamber 12 is the high side, having higher pressure pressurized air, and that the second side 22 of the test chamber 12 is the low side, having lower pressure air that has permeated through the test specimen 14, with the test specimen itself separating the high side and low side of the test chamber. The flow of air permeating through the test specimen 14 between the two sides of the test chamber is indicated by the double headed air flow arrows in the diagram.

With the test system thus initialized and the desired differential pressure established, the volume of air permeating through the test specimen and the time for that permeation to occur is measured as will now be described.

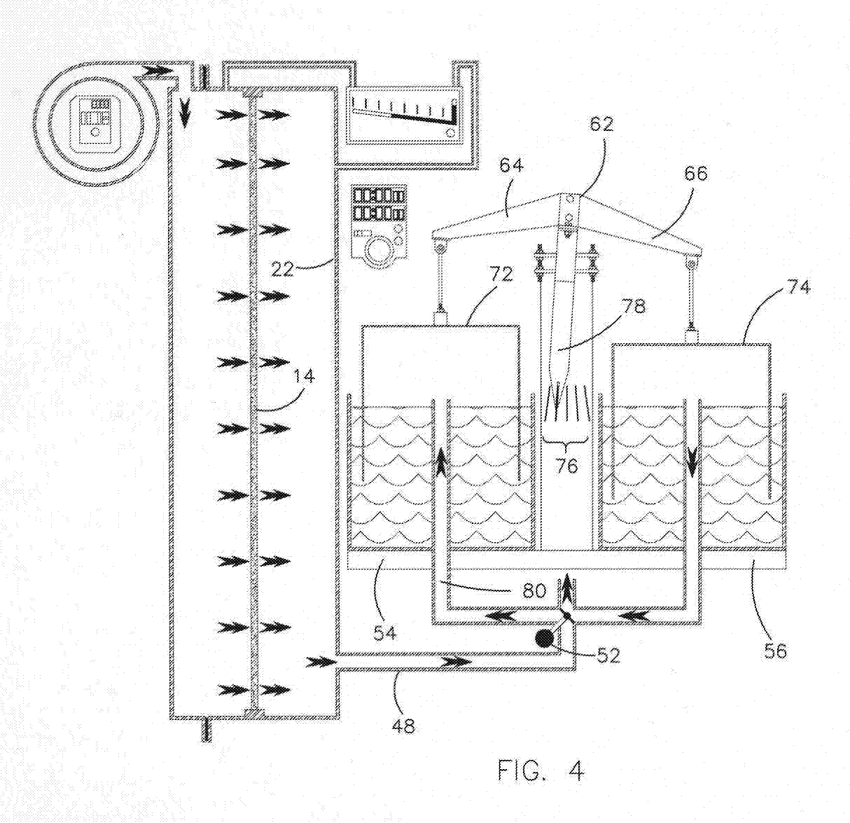

Turning to FIG. 4, the volume of air permeating through the test specimen 14 will be measured using air volume measurement device 16, the elapsed time of the test will be measured using timer 18. As the testing is described, it will be apparent that the measurement of the volume of air is achieved by alternately and successively measuring the volume of air captured in each of the float boxes 72, 74 of the measurement device 16, with the total volume of air cumulatively summed. It should be understood that this alternating method of testing allows the use of reasonably sized float boxes to measure greater volumes of air than either or both float boxes can hold. It should be further understood that float boxes having a greater volume may be employed within the scope of the invention, although such larger boxes may be more unwieldy to move and operate.

As depicted in FIG. 4, the directional valve 52 is initially positioned so that air flowing from the second side of the chamber 22 through outlet port 48 is directed to the first float box 72 (the leftmost float box in the figure) through tube 80. As is apparent from the figure and as discussed above, this air flow is air that has permeated through the test specimen 14. As the permeated air flows into the first float box 72, the accumulated volume of air in that float box causes the float box 72 to rise within the water tank 54, causing the corresponding end 64 of the fulcrum 62 to rise, which in turn moves the dial indicator 78 along the deflection scale 76. The deflection scale 76 and dial indicator 78 are monitored until the volume of air in the first float box 72 reaches 72 cubic inches—i.e., until the dial indicator reaches the first index line on the deflection scale as described above.

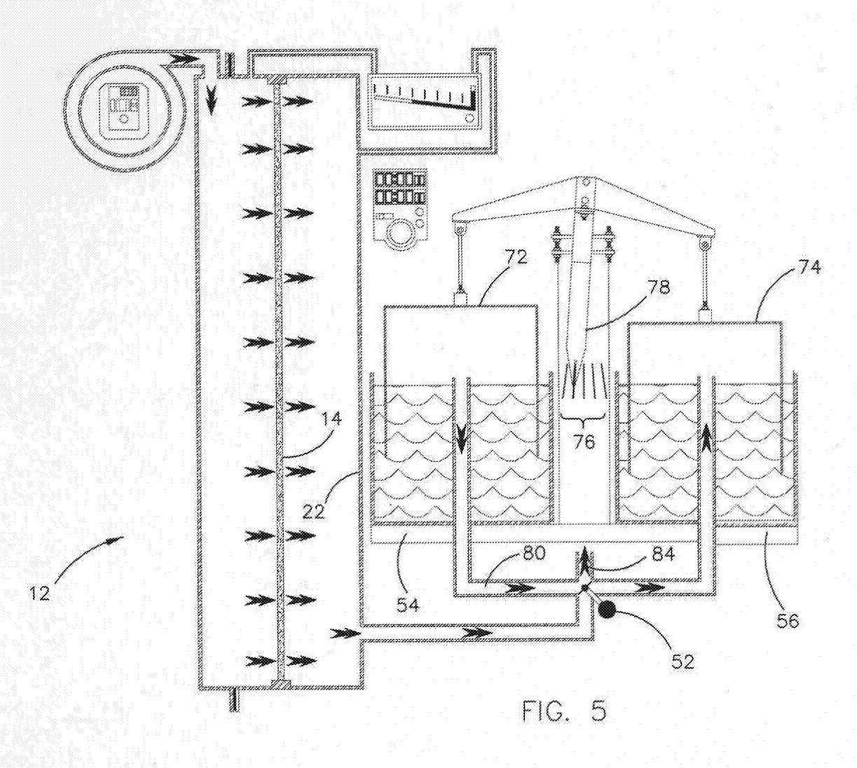

As shown in FIG. 5, immediately upon the dial indicator 78 reaching the first index line towards the first float box, indicating that 72 cubic inches of air have entered the first float box, the directional valve 52 is turned so that air flows into the second float box 74 (the rightmost float box in the figure) through tube 82. With the directional valve 52 thus oriented, air from the second side 22 of the chamber 12 is directed into the second float box 74, and air from the first float box 72 is vented to the atmosphere through tube 80 and vent tube 84.

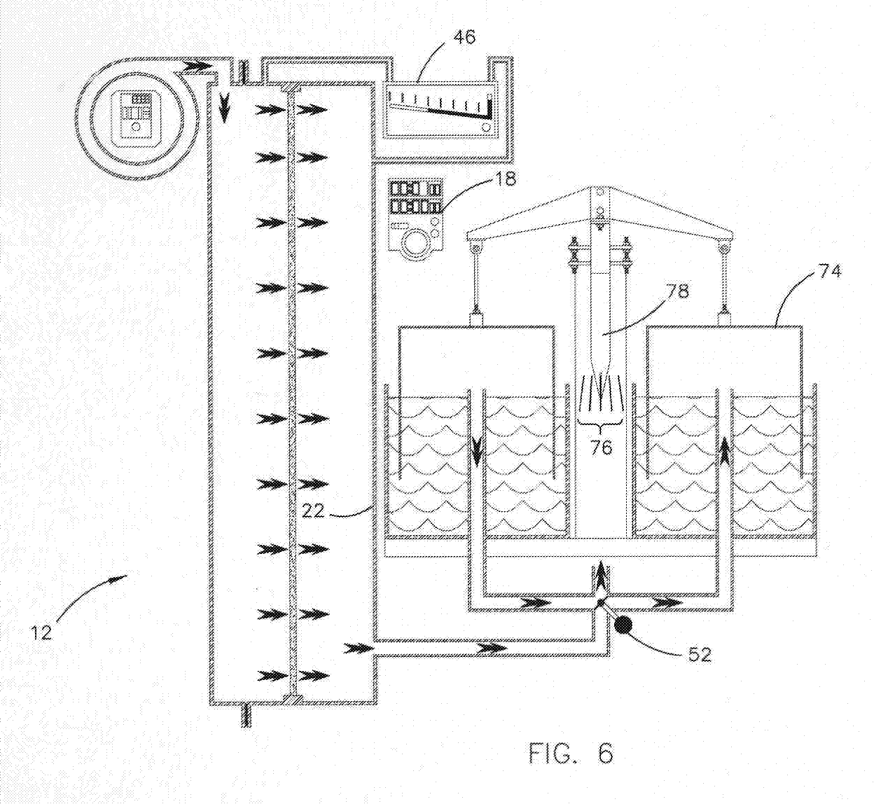

Turning to FIG. 6, the position of directional valve 52 and the system configuration (e.g., the differential pressure as indicated on manometer 46) are maintained as the air from the second side of the chamber 22 fills the second float box 74, causing the dial indicator 78 to begin transitioning towards the second float box. As soon as the dial indicator 78 reaches the center index line (indicating that the float boxes are at an equilibrium state) the electronic timer 18 is started to begin measuring the elapsed time for the steps of capturing a volume of air from the second side 22 of the chamber 18 that will follow.

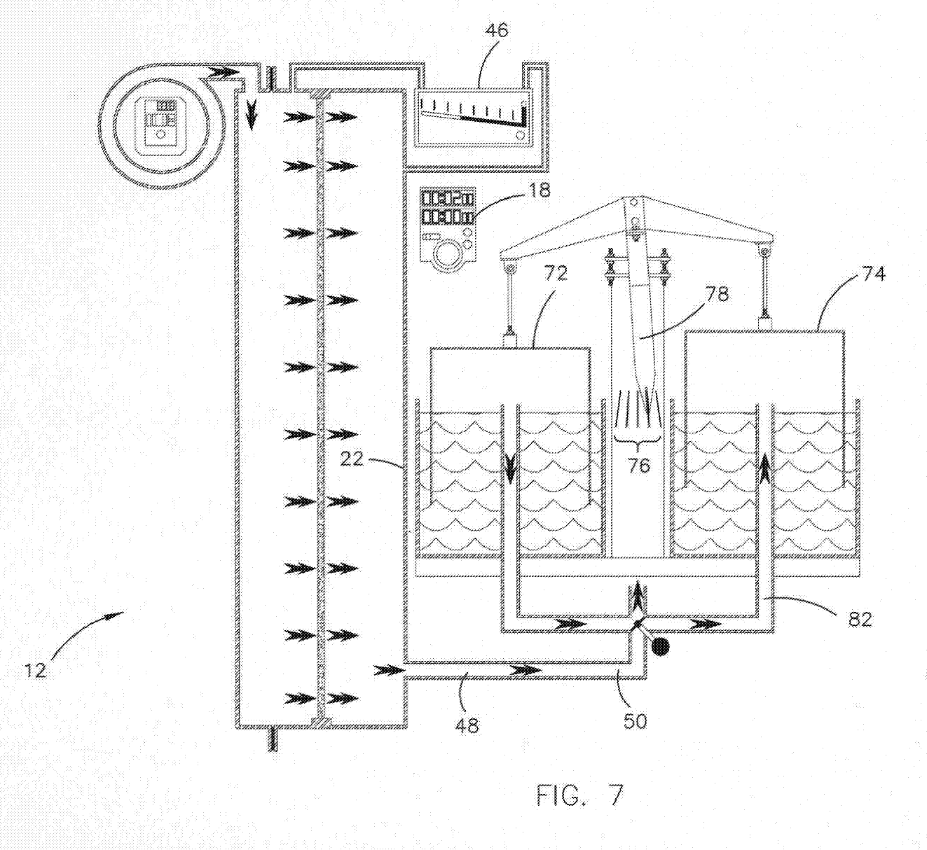

As shown in FIG. 7, as the timer 18 continues to run, air from the second side 22 of the chamber 12 continues to flow through outlet port 48, past directional valve 52, through tube 82, and into the second float box 74. As depicted in the figure, the dial indicator 78 points to the first index mark, indicating that the second float box has received 72 cubic inches of air.

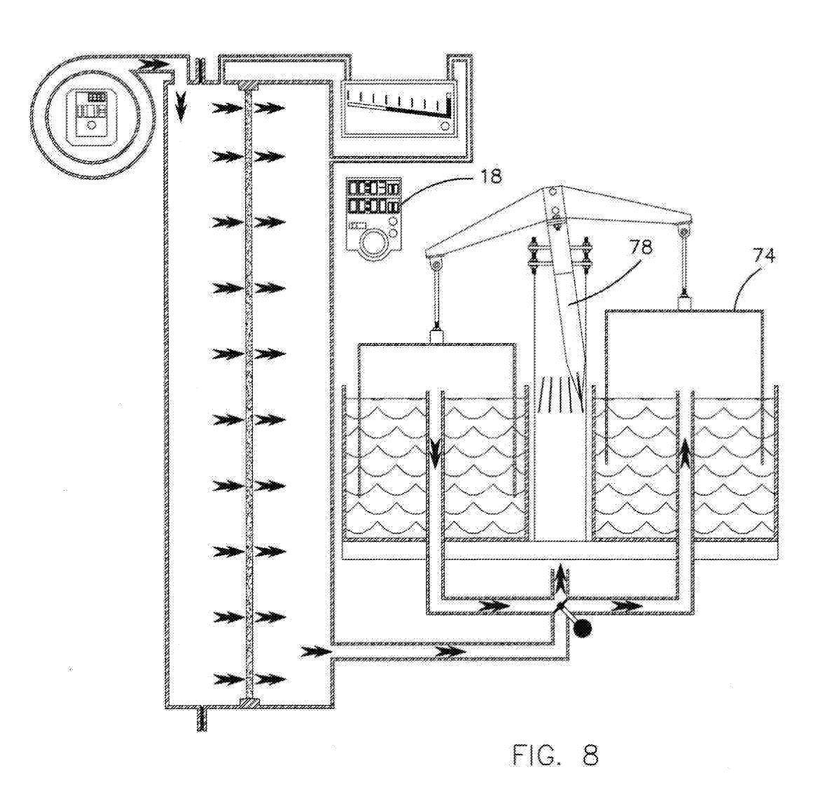

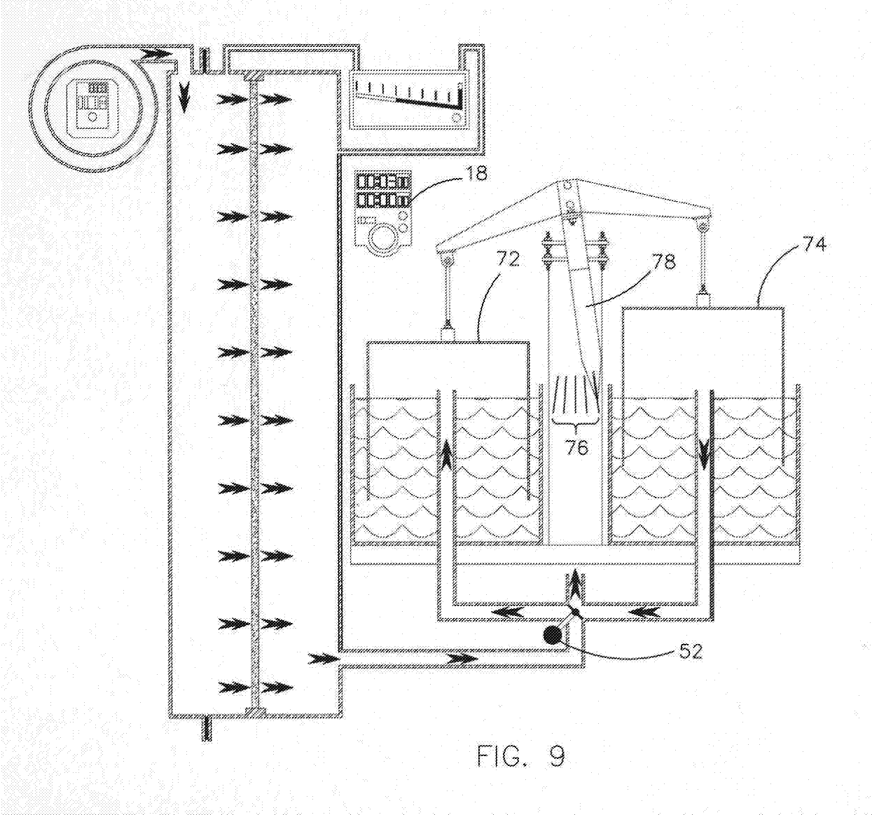

Looking to FIG. 8, as the timer 18 continues to run, the dial indicator 78 points to the second index mark towards the second float box, indicating that the second float box has received 144 cubic inches of air. As shown in FIG. 9, immediately upon the dial indicator 78 reaching the second index line towards the first second float box (indicating that 144 cubic inches of air have entered the second float box), the directional valve 52 is switched so that air again flows into the first float box 72. The measured 144 cubic inches of air that flowed into the second float box 74 is noted, and as will be demonstrated in the following steps, additional measurements of air volume will be accumulated to that initial 144 cubic inches as the test continues.

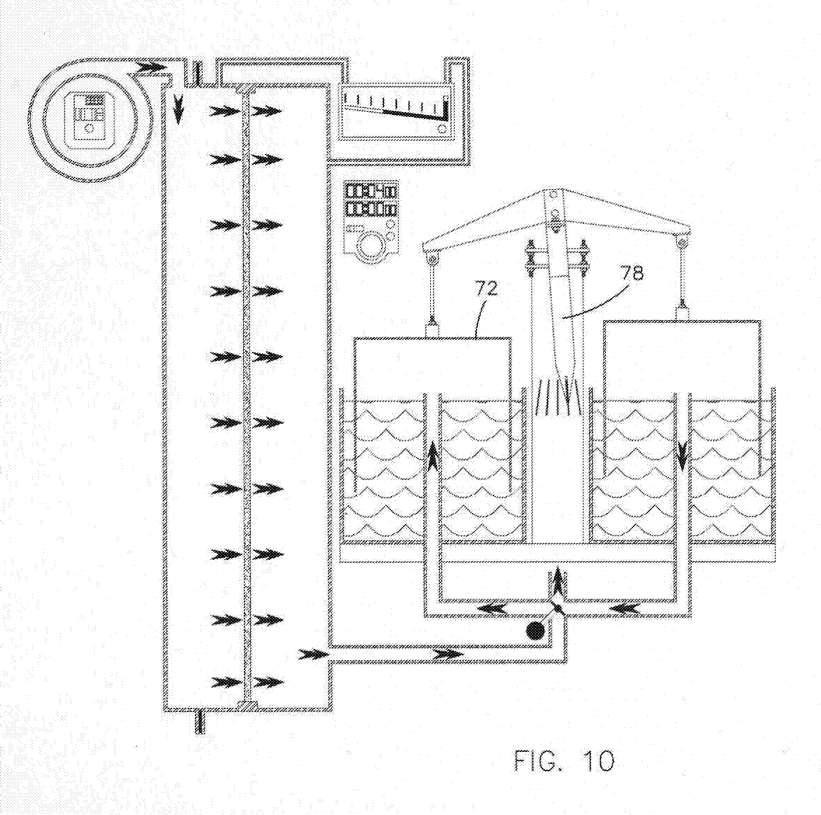

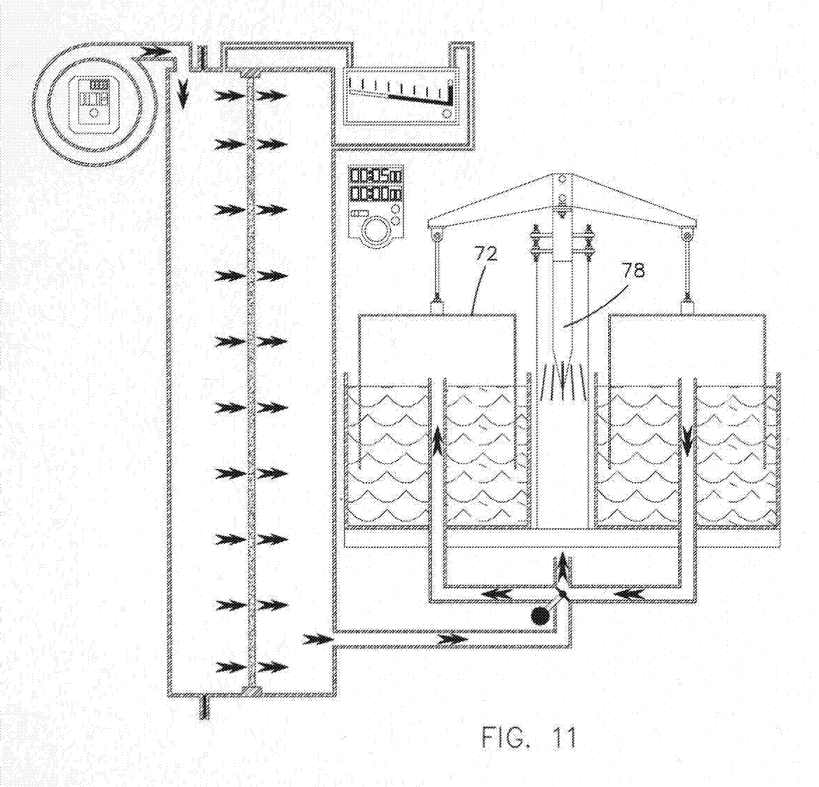

As shown in FIG. 10, when the dial indicator 78 moves back toward the first float box 72 by one index mark, that indicates that 72 cubic inches of air have flowed into the first float box. And, as seen in FIGS. 11, 12, and 13, each successive 72 cubic inches of air flowing into the first float box 72 moves the dial indicator 78 one more index mark towards the first float box.

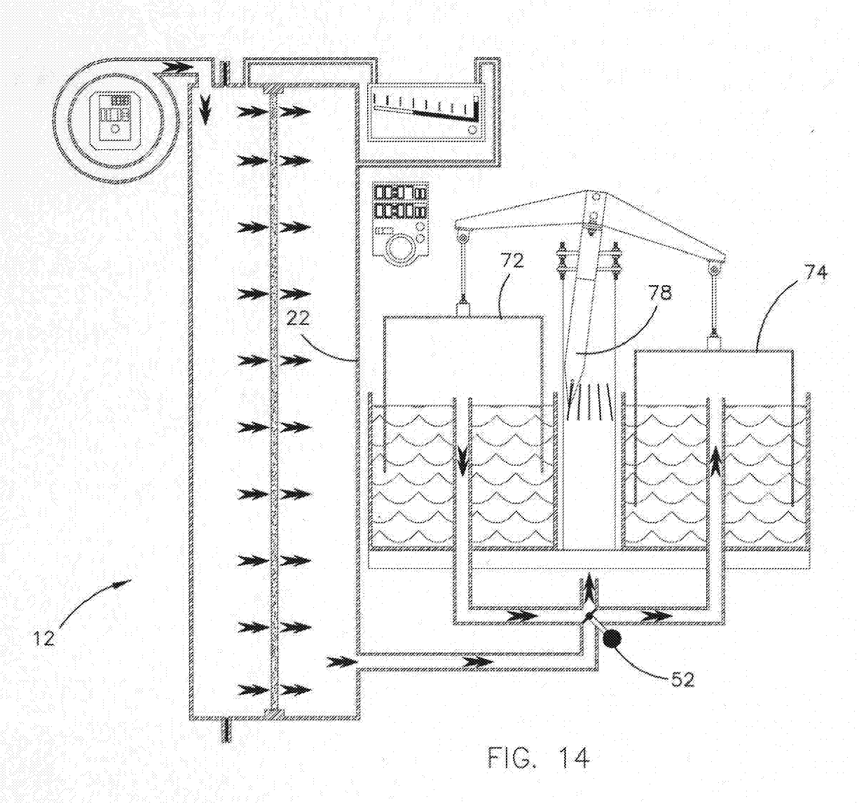

Turning to FIG. 14, when the dial indicator 78 reaches the second index mark towards the first float box 72, that indicates that 288 cubic inches of air have flowed into the first float box (i.e., the dial indicator has moved four index lines towards the first float box since the directional valve was last switched), for a cumulative total of 432 cubic inches of air measured since the timer 18 was started (the 144 cubic inches initially measured plus the 288 cubic inches just measured). At this time, as depicted in FIG. 14, the directional valve 52 is again switched so that air from the second side 22 of the chamber 12 is directed again to the second float box 74.

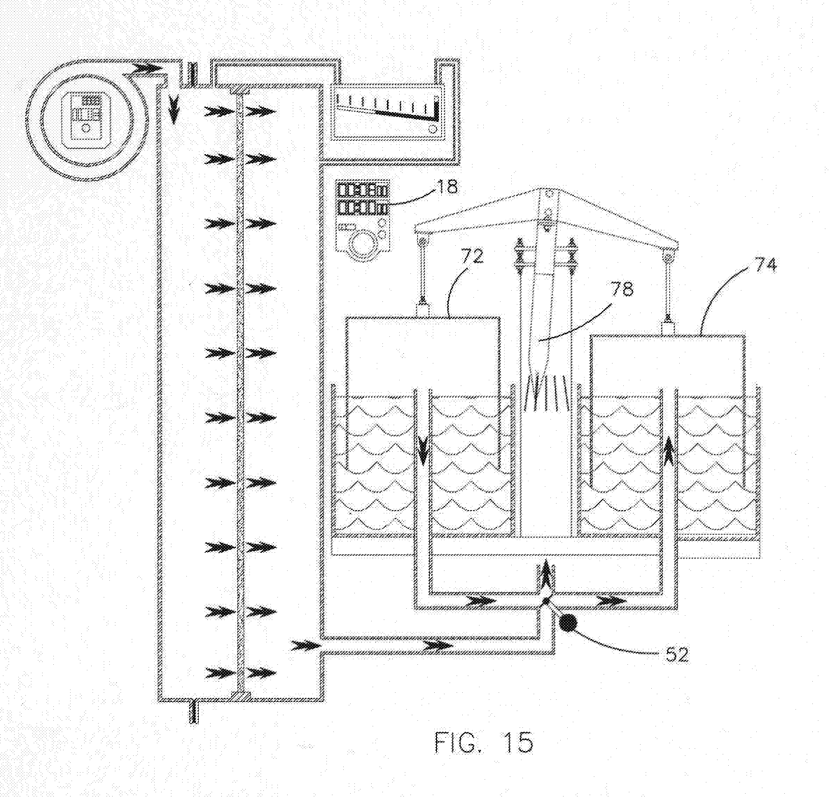

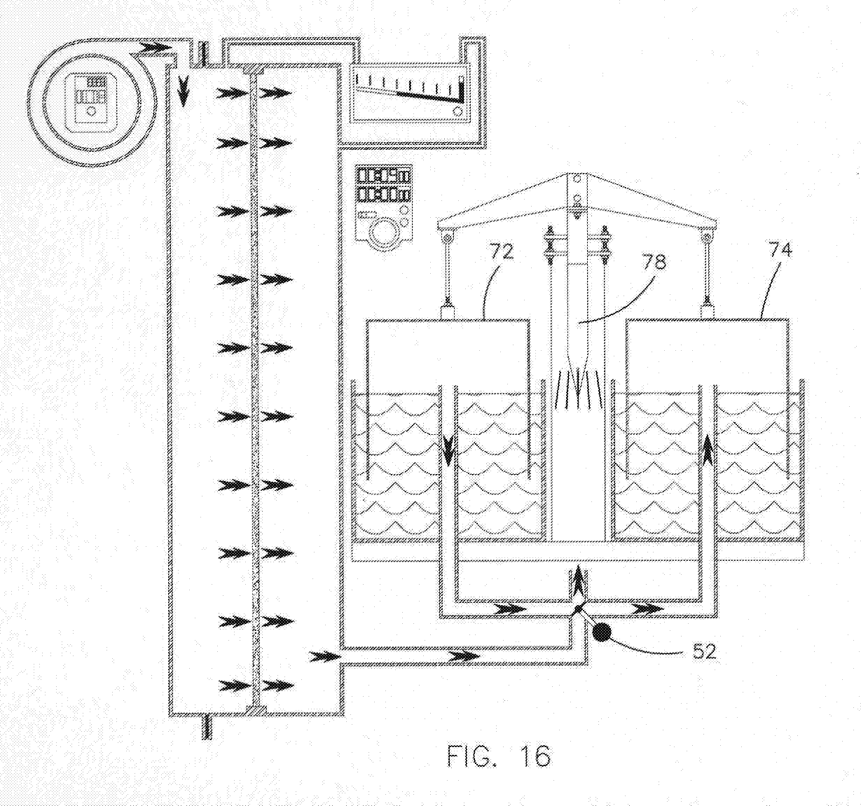

As depicted in FIGS. 15 and 16, the timer 18 continues to run as the air from the second side 22 of the chamber 12 is directed into the second float box 72, causing the dial indicator 78 pointer to move back towards the second float box.

As seen in FIG. 16, when the dial indicator reaches the center index line, an additional 144 cubic inches of air has flowed into the second float box 74, and the time 18 is stopped to capture the total elapsed time for the test. That additional 144 cubic inches is added to the prior cumulative total of 432 cubic inches, resulting in a final total volume of 576 cubic inches of air captured over the duration of the test. Thus, in the example just described, a volume of 576 cubic inches of air and/or water vapor permeated through the test specimen material over a period of 9 minutes.

Using the total volume of air captured, the total elapsed time, and the area of the test specimen, the permeability of the test specimen 14 can be calculated in terms of cubic feet of air per minute per square foot of specimen, at a specific differential pressure. It should be understood that the volume, time, and test specimen area can be expressed in any desired equivalent units—for example, a conversion from square inches to milliliters, from seconds to minutes, or from square meters to square feet can be performed as is known in the art to achieve the units desired.

From the description just provided, it should be understood that the test methodology as just described can be adapted as necessary for various test specimens, and that the number of iterations of switching back and forth between the float boxes can be modified as necessary or desired. For example, if a specimen has very low permeability, the length of time the test is performed may be increased so as to increase the volume of air captured. It should also be understood that, as discussed above, the size of the water tanks and the float boxes may be adjusted as desired or necessary for a particular test. Larger water tanks and float boxes may be used to minimized the number of iterations in switching from the first float box to the second float box, or may be used in conjunction with specimens having a higher permeability. These and other variations are contemplated by, and are within the scope of the present invention.

It should also be understood that while the testing system of the exemplary embodiment have been described as being manually operated (e.g., the directional valve 52 is operated manually), as discussed above, the instrumentation and controls may likewise be electronically controlled and in communication with each other and/or a central controller or processor such that the testing procedure may be partially or fully automated.

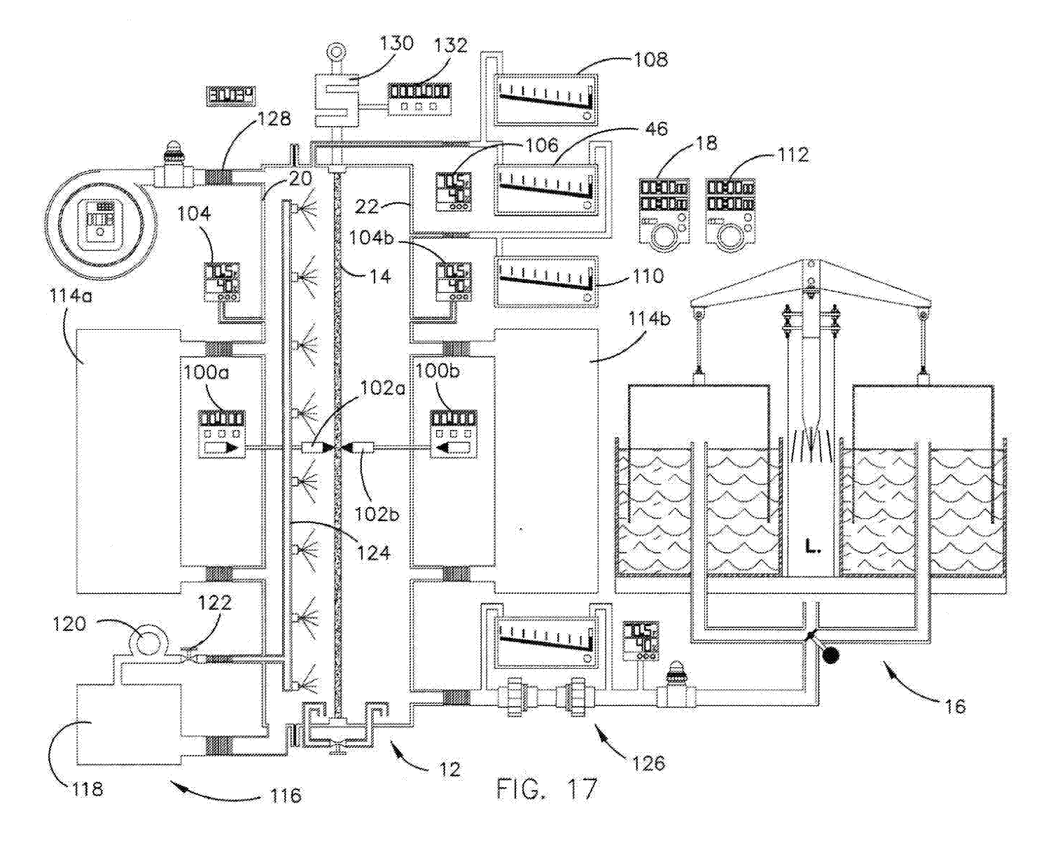

With the operation of the test system and method of the present invention set forth, various alternative configurations will now be disclosed and discussed with reference to FIG. 17.

As shown in FIG. 17, the test chamber 12 as previously described with respect to FIG. 1 may further include one or more dimensional change measuring devices 100a, 100b, and associated sensors 102a, 102b operable to measure changes in the thickness of the specimen 14 being tested. Such dimensional changes may occur, for example, when the test specimen expands when exposed to water spray. The measuring devices are preferably initially calibrated to a zero or nominal value with any changes occurring during testing displayed in the desired dimensional units. As previously discussed, the measuring devices preferably are electronic and include capability to communicate with other instrumentation and/or a controller or processor.

The test system may further alternatively include temperature and humidity monitors 104a, 104b in fluid communication with the interior of the first side 20 and second side 22 of the test chamber 12, respectively, to provide data representative of the air temperature and humidity in each side of the chamber. The system may alternatively include a temperature and humidity monitor 106 for measuring the corresponding ambient air parameters.

Looking still to FIG. 17, in addition to the differential pressure manometer 46 as previously described, the test system may further alternatively include individual manometers 108, 110 to measure the air pressure in the corresponding first and second sides 20, 22 of the test chamber 12. The test system may further include an additional timer 112 for measuring other events during testing.

Environmental control devices 114a, 114b may alternatively be attached to the first or second sides 20, 22 of the test chamber 12, the devices operable to control the introduction of environmental conditions, such as heated or cooled air, to either side of the test chamber. Similarly, a water spray device 116, comprising a water reservoir 118, a pressure gauge 120, a control valve 122, and a water spray grid 124, may alternatively be included to allow the introduction of water spray to the test specimen 14.

As will be described in more detail below, setup of a calibration orifice plate 126 may alternatively be used to calibrate and verify the test chamber and test setup.

As depicted in FIG. 17, a series of isolation bellows 128 are used between the junctions between any external systems as just described and the test chamber 20. The isolation bellows are airtight, flexible bellows connections that permit the external systems to be in fluid communication with the test chamber 20, while allowing the test chamber to move independently of and unencumbered by the external system. Thus, as will now be described, the weight of the test chamber can be monitored during testing to measure any changes that occur.

A weight measuring device 130 and associated display 132 can alternatively be used with the test chamber. With the test chamber 20 isolated from the external systems via the isolation bellows 128 as just described, and a test specimen mounted as previously described, the entire chamber 20 is suspended from a weight measuring device such as a strain gauge. During testing, any changes to the weight of the test chamber, such as by the absorption of water spray by the test specimen 14, or the release of water as the specimen dries, is measured by the weight measuring device, with the change indicated on the display 132.

As discussed above, preferably the instrumentation and systems are capable of communication with each other and/or a central controller such that data may be shared between devices and systems and/or may be controlled automatically by a central controller.

As just described, it should be apparent that the test systems and methods of the present invention are well-adapted to perform precise and accurate measurements of the permeability of materials under real-word conditions. It should be understood that an initial pressure drop test may be performed on the test chamber setup to ensure that there are no leaks in the system, and that the entire system may be calibrated using an orifice plate (e.g., orifice plate 126) having a known flow rate as will be described below. It should be further understood that the testing preferably occurs over a period of time in which the atmospheric conditions are relatively stable as changes in atmospheric air pressure and temperature can affect the testing accuracy.

While various test parameters and instrumentation have been set forth and discussed herein, it should be understood that the test system of the present invention offers accuracy and abilities not currently possible with known test equipment. For example, the quality and content of the air transmitted can be monitored and measured, and the dimensional stability, mold growth potential, and change in air transmission rate of the specimen being tested can be measured and/or calculated using the test system and method of the present invention. In addition, with the ability to measure the weight of the specimen as described previously and the ability to accurately and precisely measure the volume of air permeating through a test specimen, the system and method of the present invention may be used to determine whether air flow and water vapor flow or transmission occur simultaneously or separately.

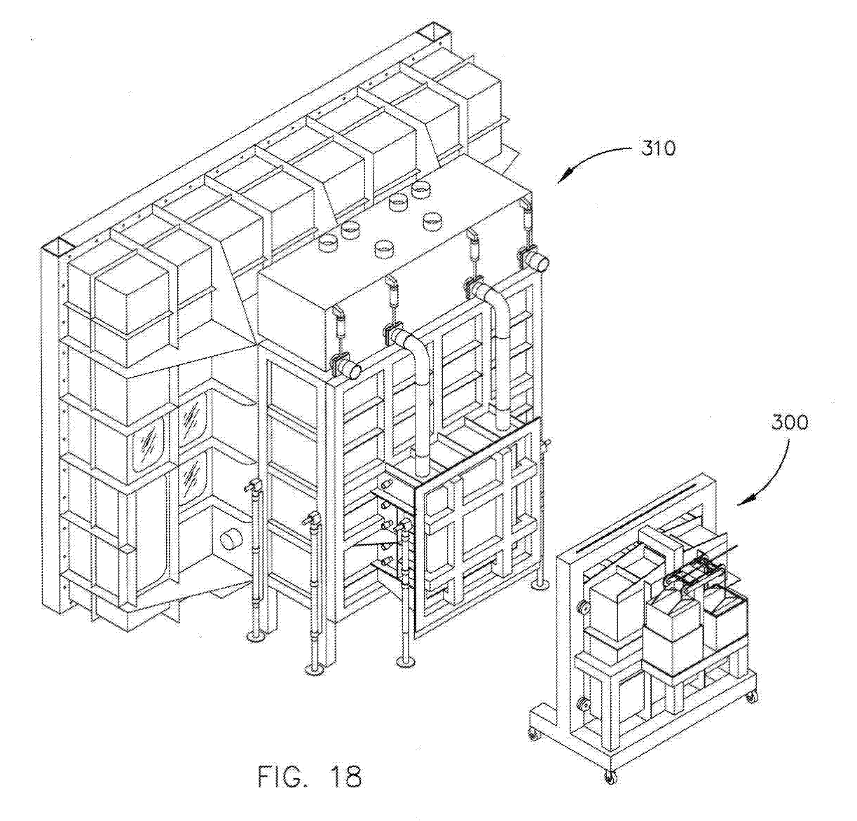

FIG. 18 depicts the test system 300 of FIG. 1 used in conjunction with a storm surge chamber 310. A storm surge chamber is a device used to simulate, among other things, wind and water conditions associated with severe storms, such as hurricanes. In use with the system of the present invention, with the test specimen mounted in the test chamber 300 as previously described, the test chamber 300 of the present invention is mated to the storm surge chamber 310 with the first side of the test specimen (i.e., the side of the test specimen exposed to the first side of the test chamber) exposed to the conditions generated by the storm surge chamber.

The storm surge chamber 310 can generate extreme wind and water conditions such as those associated with a hurricane or tropical storm. After the storm surge exposure, the test chamber 300 is separated from the storm surge chamber, and permeability testing of the material test specimen is performed in a manner as described above. Thus, the storm surge chamber 310 exposes the test specimen to real-world conditions, the test chamber 300 is then used to test that real-world exposed test specimen so that accurate permeability measurements can be obtained. In alternative embodiments, permeability testing of a specimen using test chamber 300 is conducted while the test chamber 300 is attached to the storm surge chamber 310.

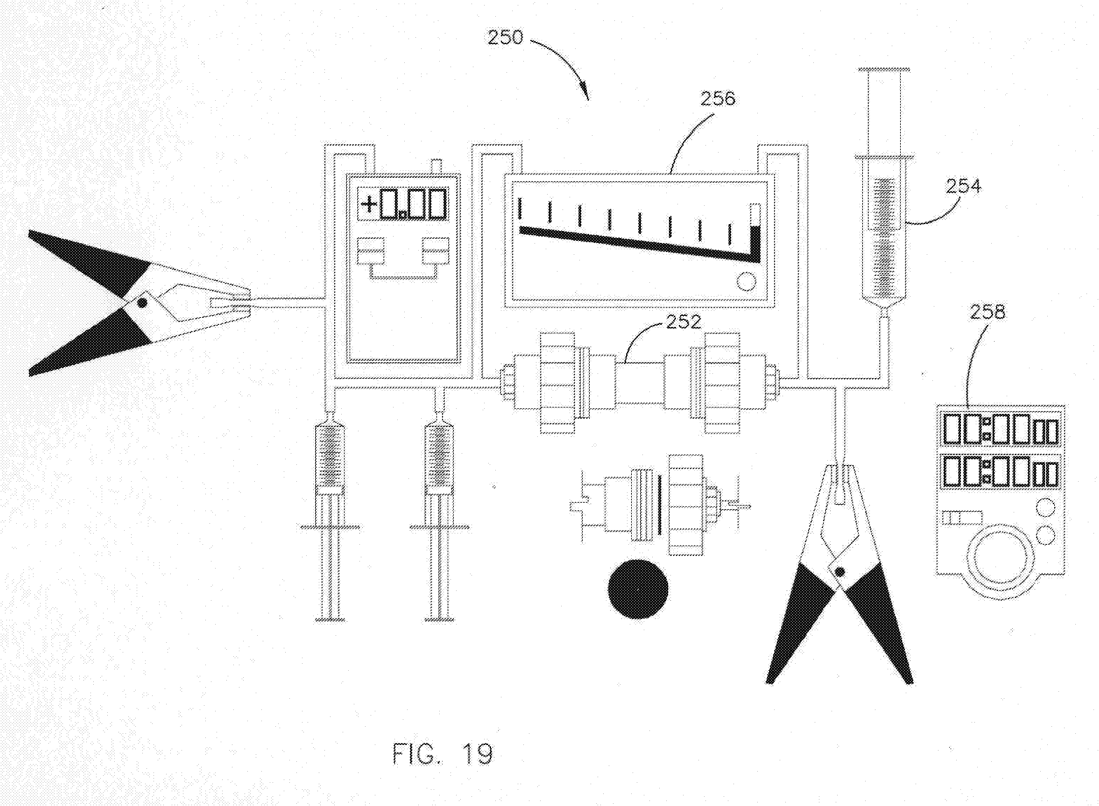

Looking to FIG. 19, a schematic depiction of a system for calibrating an orifice plate for use in calibrating a test system, such as that described above with respect to FIG. 17, is depicted generally by numeral 250. In operation and use, the flow of air through an orifice plate 252 is determined using a syringe 254 to apply a known volume of air at a desired pressure through the orifice plate 252, with a manometer 256 used to monitor the pressure as it is applied to allow the operator to maintain a constant desired pressure as the syringe 254 is depressed. The time for the volume of air from the syringe 254 to flow from the syringe is measured by timer 258, so that the rate of flow of air through the orifice plate 252 at the given pressure can be determined. With the orifice plate thus calibrated, that calibrated orifice plate 252 is then installed in the test system configuration as depicted in FIG. 17 to verify that the flow rate of air through the calibrated orifice plate when installed in the test system is the same as the rate determined on the test bench. Any discrepancies indicate a potential leak in the test chamber configuration. Thus, the integrity and accuracy of the test system can be confirmed at any time by testing the calibrated orifice plate.

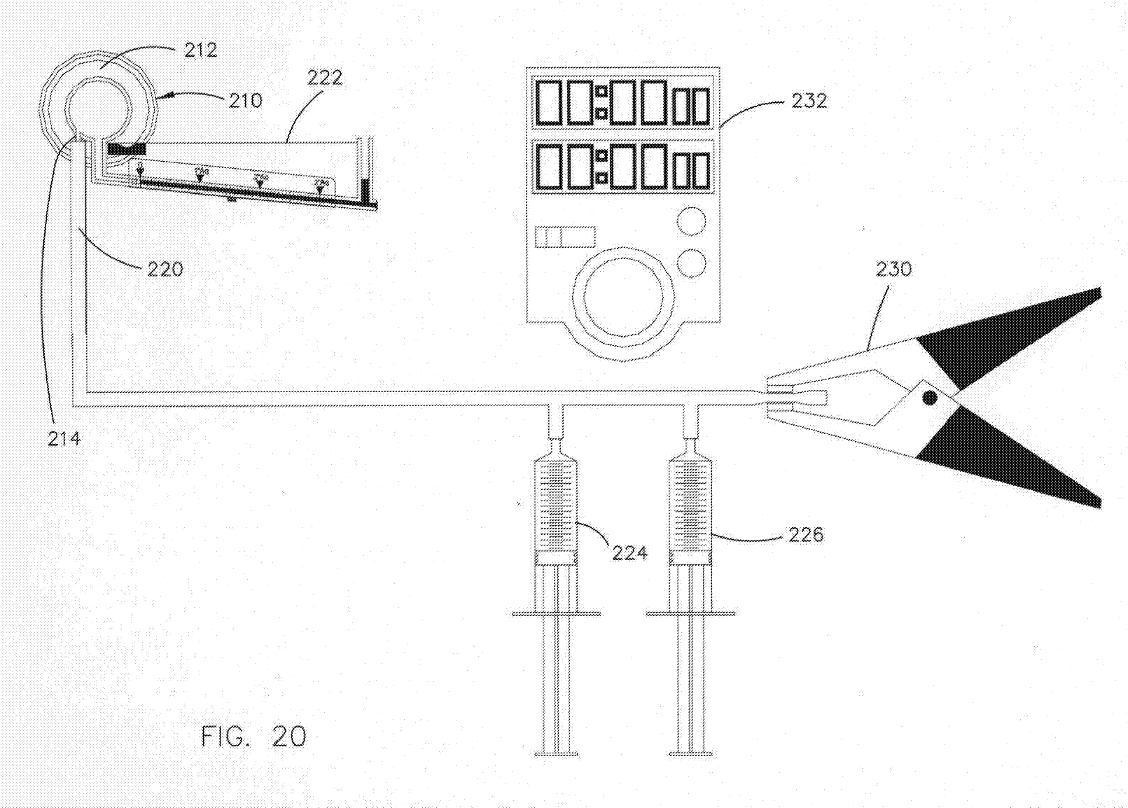

Turning to FIG. 20, an exemplary embodiment of a field test system and device for measuring the permeability of a material in a manner analogous to that described above with respect to the test system describe above with respect to FIGS. 1 through 17 is depicted. The field test device is in essence a minimized version of the test system described previously, operating in a similar manner but on a smaller scale to allow bench and remote field testing of materials and structures. The field test configuration allows testing and measuring the permeability of a material on-site or at an actual building location rather than in a test laboratory, and further allows testing a localized area of a test specimen, such as in a small area surrounding a fastener extending through the specimen material.

The field test configuration operates in a manner similar to the test chamber configuration in that the permeability of a material (or a portion of that material) can be precisely and accurately measured. The field test configuration, however, does not include a number of the parameter measuring devices of the full test chamber as described above with respect to the exemplary embodiment of FIGS. 1 through 17, and does not include any of the automatic controls as described with respect to the full test chamber.

As shown in FIG. 20, an exemplary embodiment of the field test configuration includes a test cup 210 having a flange 212, formed integrally with an incline manometer 210.

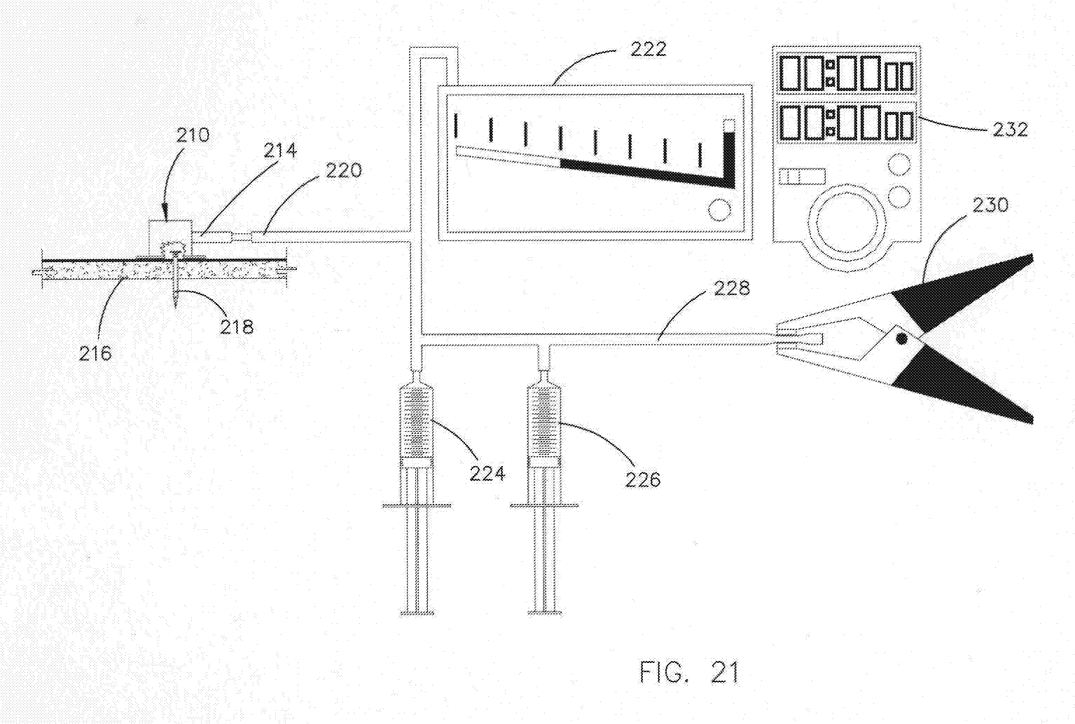

Turning to FIG. 21, a schematic diagram of the field test configuration of FIG. 21 shows that the field test permeability measuring system comprises test cup 210 having a flange 212 extending around the perimeter of the open end of the cup, and an inlet tube 214 extending from the wall of the cup so that the inner bore of the inlet tube is in fluid communication with the inner cavity of the cup 210. The cup is installed with the flange 212 secured to a specimen or material 216 to be tested, in a localized area of interest, such as in the area surrounding a fastener 218 driven through the material.

A tubing assembly 220 connects the inlet tube 214 of the cup to an incline manometer 222, to first and second syringes 224, 226, and to a vent tube 228 so that all of the devices are in fluid communication such that air can flow freely between the devices. The connections between the tubing assembly 220 and the devices are sealed so that there is no leakage of air into or out of the system. A vent clamp 230 is used to pinch and seal the end of the vent tube 228. A timer 232 is used to measure the amount of time required for a predetermined volume of air in the syringes to permeate through the material around the fastener.

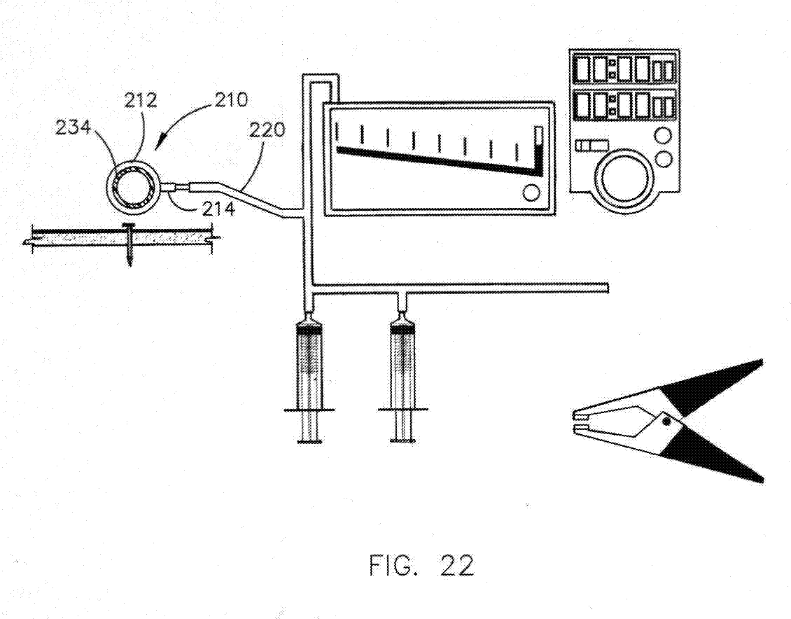

With the elements of the field test configuration set forth, the use and operation of the field test permeability measurement device will now be described with reference to FIGS. 22 through 30.

Looking to FIG. 22, a quantity of air seal putty 234 is formed into a ring and place onto the lower surface of the flange 212 extending from the circumference of the open end of cup 210. The inlet tube 214 extending from the cup is attached to the tubing assembly 220 as previously described. The air seal putty 234 is a flexible, resilient sealant designed to adhere the flange 212 to the surface of the material being tested and to form an airtight seal between the two.

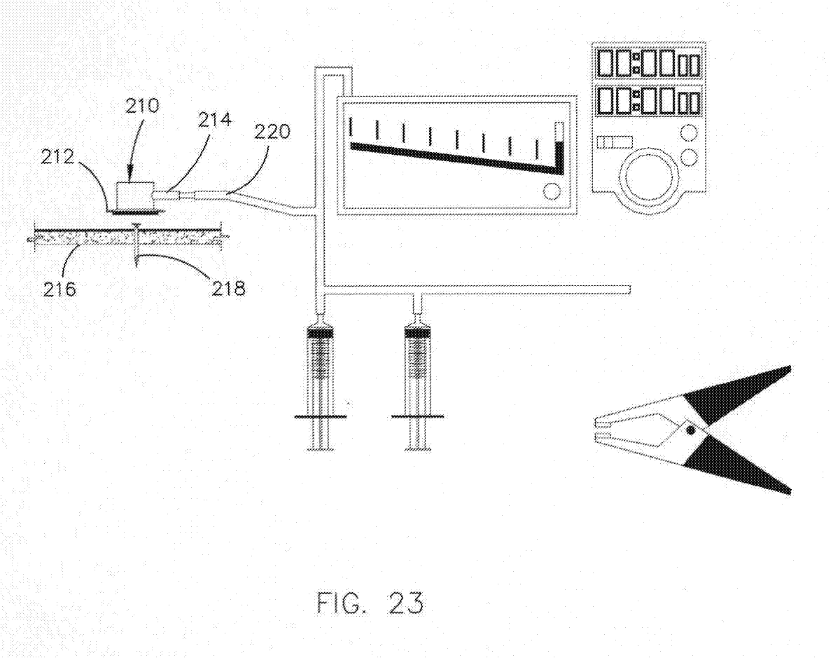

Turning to FIG. 23, with the ring of sealant putty 234 in place on the flange, the test cup 210 is inverted into position over the test specimen material 216 in the area where the fastener 218 penetrates the material. The cup is pushed into place onto the material, squeezing the putty so that it fills any gaps or voids between the material 216 and the flange 212, forming an airtight seal between the two. Preferably, the cup is slightly rotated or twisted back-and-forth while pressure is applied to thoroughly distribute the putty 234 between the flange 212 and the surface of the material 216.

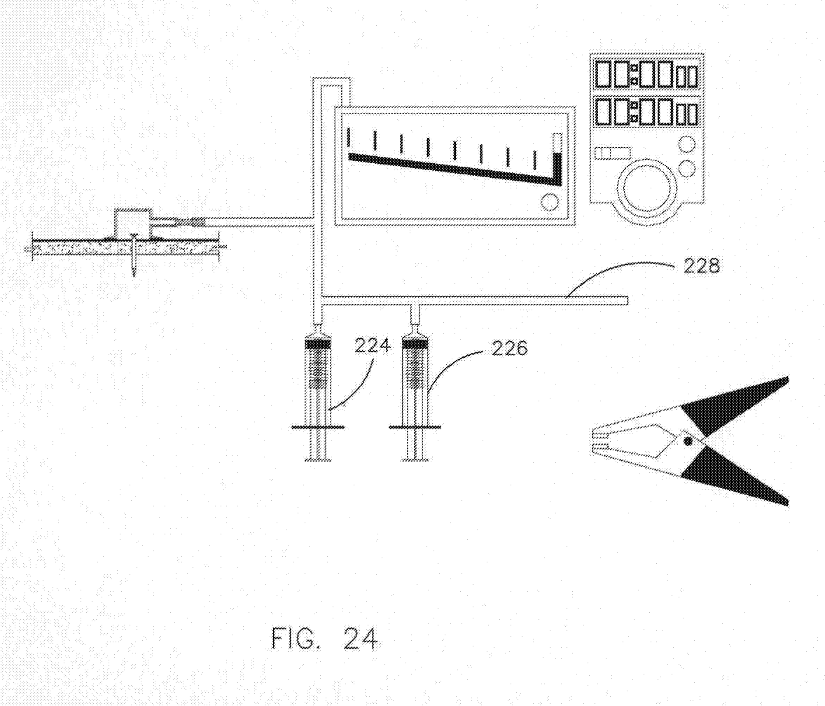

Looking to FIG. 24, with the cup in place and sealed to the material by the putty, 10 milliliters of air is drawn into each of the syringes 224, 226 by retracting the plungers to draw in ambient air through the open vent tube 228.

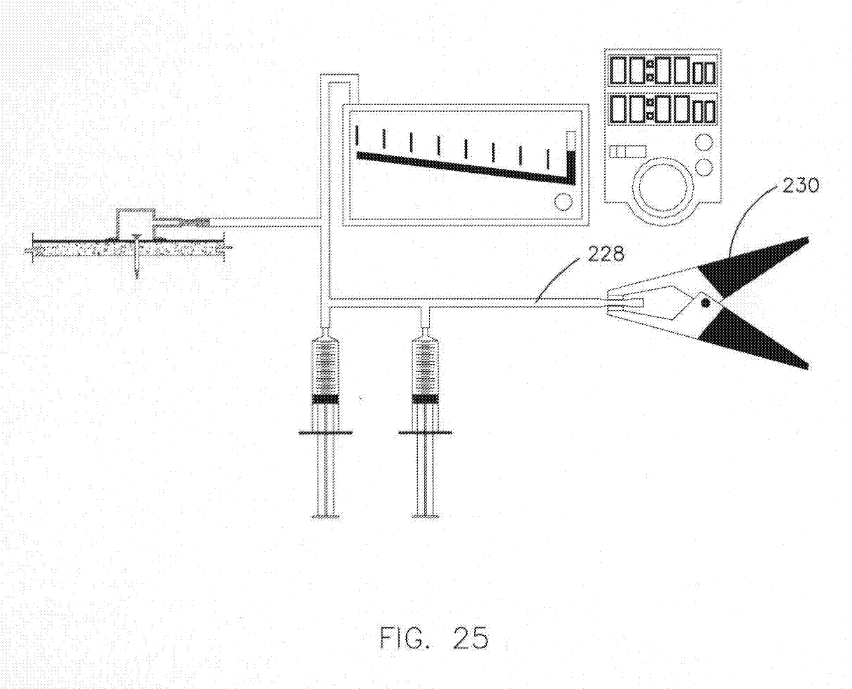

Turning to FIG. 25, with the syringes filled with the desired amount of air (10 milliliters each), the vent clamp 230 is placed onto the open end of vent tube 228, sealing it and preventing any air from entering or escaping the tubing assembly.

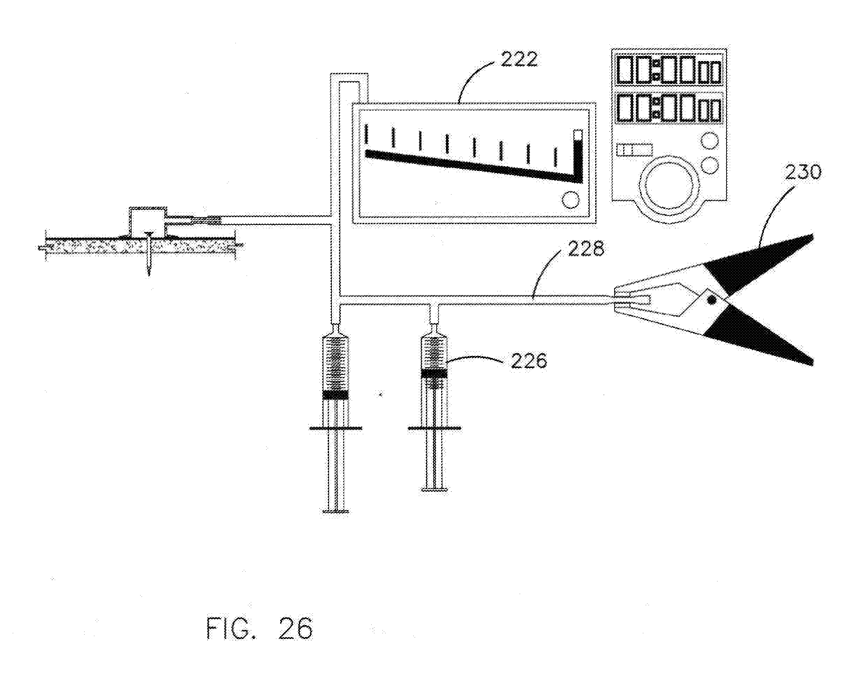

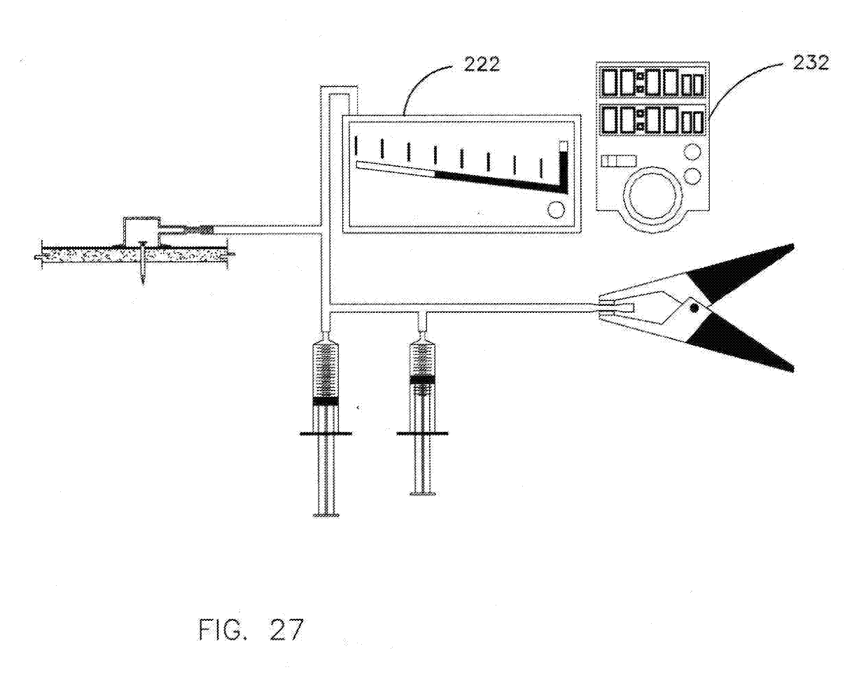

As shown in FIG. 26, the incline manometer is pre-charged with air to a pressure of 0.3 inches of water (in. Aq) (or to any other desired pressure) by depressing the plunger of the pre-charge syringe 226 until the desired pressure is attained. It should be understood that with the system sealed (the cup is sealed to the surface of the material being tested; the tubing assembly is sealed to the cup inlet tube, to the syringes, and to the manometer; and the vent tube is sealed by vent clamp 30) and pressurized to 0.3″ Aq, that any air leakage is attributable to air permeating through the portion of the material being tested and/or around the fastener extending through the material. As shown in FIG. 27, with the system thus pressurized, the timer 232 is immediately started.

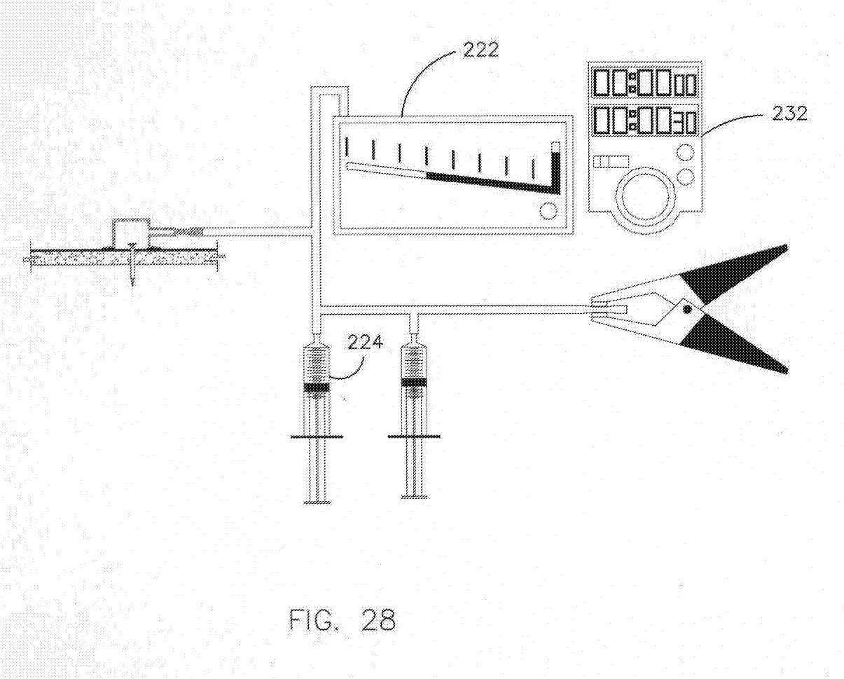

Turning to FIG. 28, as the timer runs and as air permeates out of the system around the fastener, the operator maintains the desired 0.3″ Aq pressure by manually depressing the plunger of syringe 224. That is, as air permeates past the fastener, the pressure in the system will drop, the operator counteracts that pressure drop by depressing the plunger to maintain the desired pressure.

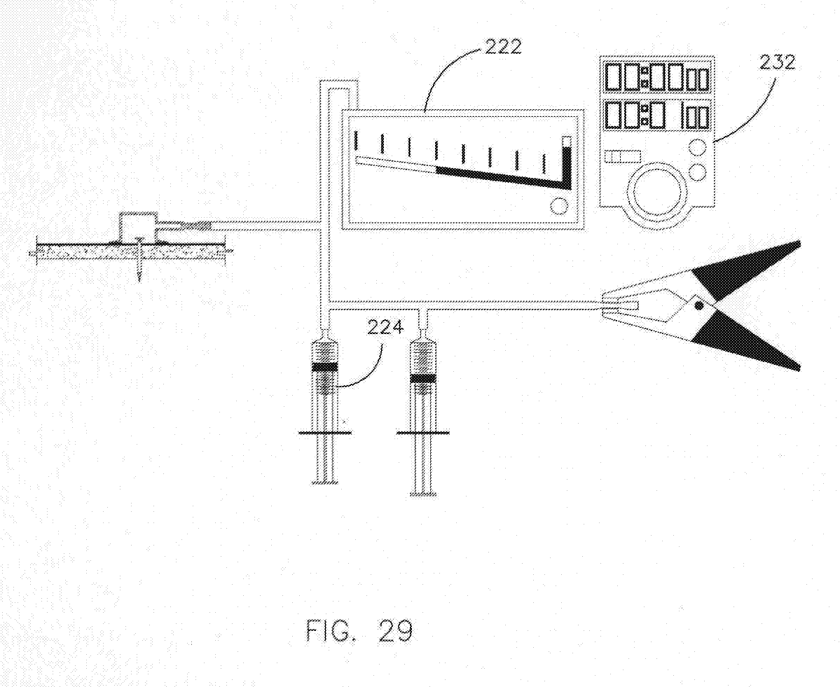

As shown in FIG. 29, when the syringe 224 is empty and the plunger fully depressed, the timer 232 is stopped to capture the elapsed time. That elapsed time represents the amount of time required for the 10-milliliter volume of air initially contained in the syringe 224 to permeate through the material around the fastener.

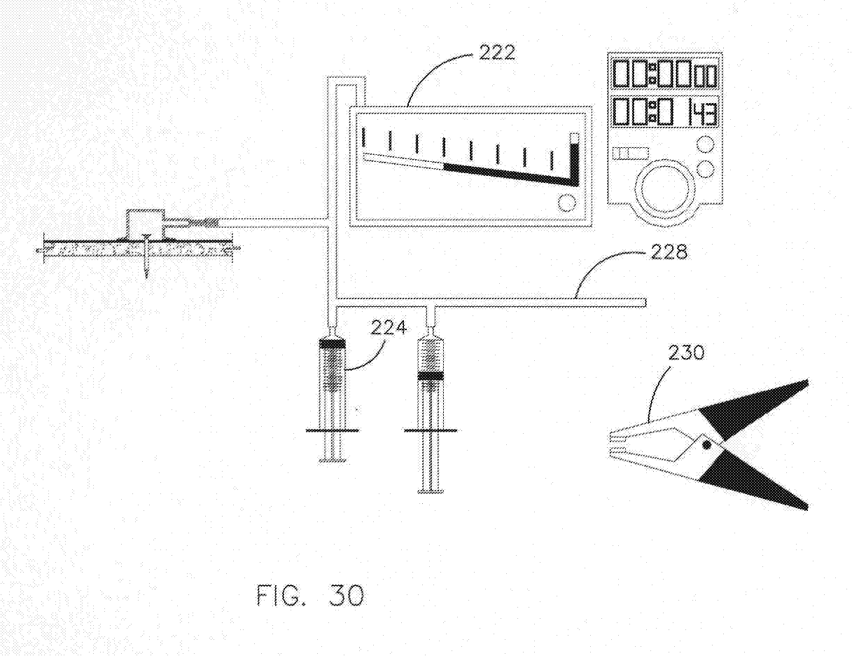

With the air volume and time data captured, as shown in FIG. 30 the vent clamp 230 is removed from the vent tube 228. The test may then be repeated as necessary for verification, or the assembly may be removed from the material and broken down for transport or for use on another test specimen.

Using the data collected, i.e.: (1) the volume of air introduced into the system through the syringe 24, 10 milliliters, (2) the elapsed time, 1 minute and 43 seconds, and (3) the pressure maintained throughout the test, 0.3″ Aq, it can be calculated that the permeation of air through the material around the fastener is 21.328 cubic inches per hour, at a pressure of 0.3″ Aq. (i.e., 10 milliliters per 1 minute 43 seconds=21.328 cubic inches per hour). Converted, this equals, 0.2057 cfm at 0.3″ Aq, 1.57 PSF or 75 Pa. Per ASTM E-2357, an acceptable rate would be less than 0.04 cfm/ft2 at 0.3″ Aq, 1.57 PSF or 75 Pa.

It should be apparent that those skilled in the art will be able to use the obtained data to compare the permeability of particular configurations of construction and barrier materials and fasteners to other materials, fasteners, and combinations to find optimal assembly and construction techniques applicable to various conditions or requirements.

Thus, it can be seen that the test systems and methods in accordance with the present invention as set forth herein are well-suited for precisely and accurately measuring the permeability of a material under real-world test conditions.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed and desired to be secured by Letters Patent is as follows:

1. A system for measuring the permeability of a material, comprising:
a test chamber having a first side and a second side, each side configured to removably attach to the other defining a space therebetween, wherein at least one of the sides comprises a mounting surface for attaching the material around its perimeter such that the material divides the chamber;
a blower in fluid communication with the first side of the test chamber to introduce pressurized air into the first side of the chamber and against a first side of the material; and
a volume measurement device in fluid communication with the second side of the test chamber operable to measure a volume of air introduced into the second side attributable to permeation through the material.

2. The system of claim 1, wherein each of the first and second sides are configured to removably attach to each other with the material affixed therebetween.

3. The system of claim 1, wherein the material is attached within the second side of the chamber and the second side of the test chamber is configured to attach to a storm surge chamber to introduce environmental conditions to a first side of the material.

4. The system of claim 1, wherein the volume measurement device comprises first and second water tanks, and having first and second inverted float boxes in fluid communication with the second half of the test chamber, wherein each float box is suspended within the corresponding water tank such that a volume of air introduced into either one of the float boxes raises its level within the corresponding tank.

5. The system of claim 4, further comprising a directional valve configured to selectively direct air from the second side of the test chamber to either one of the first float box and second float box.

6. The system of claim 5, further comprising a fulcrum having first and second arms attached to the first and second float boxes, respectively, pivotably attached between the first and second water tanks such that movement of either of the first and second float boxes correspondingly rotates the fulcrum.

7. The system of claim 6, further comprising an indicator attached to the fulcrum and operable to indicate a position of the fulcrum corresponding to the relative positions of the first and second float boxes.

8. The system of claim 1, further comprising a manometer in fluid communication with the first and second sides of the test chamber and operable to measure a differential pressure between the two.

9. A system for measuring the permeability of a material, comprising:
a test chamber having first and second sides removably sealed together, wherein one of the sides comprises a continuous support surface extending around an interior surface of the side, the support surface configured to sealably attach to a perimeter of the material such that the material divides the chamber into two compartments;
a blower in fluid communication with the first side of the test chamber to introduce pressurized air into the first side of the chamber and against a first side of the material;
a manometer in fluid communication with the first and second sides of the test chamber and operable to measure a differential pressure between the two; and
a volume measurement device in fluid communication with the second side of the test chamber operable to measure a volume of air introduced into the second side attributable to permeation through the material.

10. The system of claim 9, wherein the volume measurement device comprises first and second water tanks, with first and second inverted float boxes attached to a fulcrum having a dial indicator, the first and second inverted float boxes in fluid communication with the second half of the test chamber, wherein each float box is suspended from the fulcrum within the corresponding water tank such that a volume of air introduced into either one of the float boxes raises its level within the corresponding tank to cause movement of the fulcrum and indication of the volume of air introduced on the dial indicator.

11. The system of claim 10, further comprising a dimensional measuring device in contact with the material and operable to provide an indication of a change in thickness of the material.

12. The system of claim 10, further comprising a weight measuring device attached to the material and operable to provide an indication of a weight of the material.

13. A method for measuring the permeability of a material, comprising:
providing a test chamber having a first side and a second side, each side configured to removably attach to the other defining a space therebetween, wherein at least one of the sides comprises a mounting surface extending around an interior perimeter of the side;
attaching and sealing the material around its perimeter to the mounting surface to divide the test chamber into two compartments;
introducing pressurized air into the first side of the test chamber and correspondingly against a first side of the material;
measuring a volume of air introduced into the second side of the test chamber over a period of time attributable to permeation through the material using a volume measurement device in fluid communication with the second side of the test chamber.

14. The method of claim 13 further comprising:
connecting a manometer in fluid communication with the first and second sides of the chamber; and
monitoring differential pressure between the first and second sides over the period of time as indicated by the manometer.

15. The method of claim 13, wherein the volume measurement device comprises first and second water tanks, with first and second inverted float boxes in fluid communication with the second half of the test chamber, wherein each float box is suspended from the fulcrum within the corresponding water tank such that a volume of air introduced into either one of the float boxes raises its level within the corresponding tank to cause movement of the fulcrum and indication of the volume of air introduced on the dial indicator.

16. The method of claim 15, wherein the volume measurement device further comprising a directional valve operable to selectively direct air from the second half of the chamber to either one of the first and second inverted float boxes.

17. The method of claim 16, further comprising the step of successively operating the directional valve and wherein the step of measuring a volume of air introduced into the second side of the test chamber over a period of time comprises successively recording the volume of air successively introduced into each of the first and second inverted float boxes over that period of time.

18. A system for measuring the permeability of a portion of a material, comprising:
a test cup having an inner cavity, the test cup configured to attach to the material surrounding the portion to be tested;
a manometer in fluid communication with the inner cavity and operable to provide an indication of a pressure in the inner cavity;
first and second syringes in fluid communication with the inner cavity, each of the syringes operable to insert air into the inner cavity upon depression by an operator of the system; and
a timer operable to record a duration of a permeability test.

19. A method for measuring the permeability of a portion of a material, comprising:
sealing a test cup having an inner cavity around the portion to be tested;
attaching a manometer in fluid communication with the inner cavity;
providing first and second syringes in fluid communication with the inner cavity;
providing a timer to record the duration of the test;
pre-charging the system to a desired pressure as indicated on the manometer by depressing the plunger of the first syringe until the desired pressure is attained;
starting the timer when the desired pressure is attained;
maintaining the desired pressure over the passage of time by depressing the plunger of the second syringe to introduce additional air volume into the inner cavity;
stopping the timer to obtain an elapsed time when the second syringe is depressed to an ending point; and
calculating the permeability of the material using the elapsed time and the volume of air introduced by the second syringe.

20. The method of claim 19, further comprising:
providing a closable vent line in fluid communication with the inner cavity;
pre-loading the first and second syringes with a volume of air by retracting the plungers of each to draw in air through the vent line;
closing the vent line to seal the system.
